(19) United States
(12) Patent Application Publication
(10) Pub. No.: US 2018/0295187 A1
(43) Pub. Date: Oct. 11, 2018

(54) IoT Solution to Monitor Controlled Environments

(71) Applicants: Ashok Sabata, Freehold, NJ (US); Bikash Sabata, Cupertino, CA (US); Karl Baumgartner, Lausanne (CH); Thierry Jayet, Lausanne (CH); Octav Chelaru, Piatra-Neamt (RO)

(72) Inventors: Ashok Sabata, Freehold, NJ (US); Bikash Sabata, Cupertino, CA (US); Karl Baumgartner, Lausanne (CH); Thierry Jayet, Lausanne (CH); Octav Chelaru, Piatra-Neamt (RO)

(73) Assignee: Ashok Ashok Sabata

(21) Appl. No.: 15/484,170

(22) Filed: Apr. 11, 2017

(51) Int. Cl. H04L 29/08; H04W 12/08; H04W 4/00; G08C 17/02; H04L 12/26; G01K 13/02

(52) U.S. Cl. CPC H04L 67/125; H04W 12/08; H04W 4/005; H04L 67/025; G08C 17/02; G01K 2013/024; H04L 43/12; H04L 43/065; G01K 13/02; G08C 2200/00; H04L 43/0817

(57) ABSTRACT

With proliferation of “Internet of Things” (IoT) type of devices, autonomous remote monitoring is becoming common. Often times monitoring is to prevent product loss or it is mandated by regulatory agencies such as the FDA or CDC or others depending on the product stored or where it is used. However, the solutions are typically not complete or affordable and have significant scalability problems. The purpose of the invention is to provide a complete solution that leverages the recent IoT innovations to not just monitor but also provide the means to troubleshoot, maintain and manage.

### REFERENCES CITED

### US Patent Documents

U.S. Pat. No. 8,725,455B2 May 2014 Kriss Richard

### US20140313048A1 October 2014 Sabata et. al.

### BACKGROUND OF THE INVENTION

With proliferation of “Internet of Things” (IoT) type of devices, autonomous remote monitoring is becoming common. In commercial space the applications are numerous and varied. Monitoring of refrigerators, freezers or any controlled environment is desirable for perishable goods. Often times monitoring is mandated by regulatory agencies such as the FDA or CDC or others depending on the product stored or where it is used. Temperature, relative humidity, carbon dioxide (CO2), power consumption and differential pressure are the most common parameters that are monitored with sensors to prevent product loss as well as meet compliance requirements. Typically, the sensor data is transmitted to the user through a wired or wireless solution such as zigbee, bluetooth, WiFi or cell phones.

In many applications monitoring is mandated. For instance, the US government has published protocols and rules for storage of blood, tissue, organs, vaccines and similar critical products. Improper storage can result in loss of potency for vaccines or the product becoming ineffective thereby posing a serious threat to the health of the patient. There are many solutions in the marketplace but none have a complete solution that uses a true IoT platform that is affordable and monitors 24/7 (24 hours, 7 days a week).

Monitoring systems are not designed to measure equipment performance, they are designed to monitor the temperature of the product stored in the storage equipment by using glycol or glass beads or similar buffering method so that it mimics the product temperature closely. U.S. Pat. No. 8,725,455B2 discloses a system to monitor the energy consumption of refrigerators and freezers using temperature and current sensors and a way to analyze the sensor data for monitoring the electrical performance of such assets. However, instrumenting such storage devices can be expensive and the monitoring an added burden that most customers are not willing to take on.

A limitation of existing solutions is their inability to scale because of the use of traditional client-server model between the sensor and the cloud. When there are tens of thousands of sensors the server side becomes the bottleneck. Though custom gateways are used to address these constraints of the server-client model, they increase cost and are inefficient. The new IoT platforms using cloud base models address many of these constraints, especially the bottlenecks, using a publish-subscribe (pub/sub) model as described in the Wikipedia article “Publish-subscribe pattern”. Solutions are being designed with these type of new platforms, but none exist that address the particulars of storage applications that not only monitor the product being stored but also track the equipment performance and additionally monitor the performance of the sensor, its history from its creation to end-of-life; all these done in a cost effective and efficient manner while providing a non-technical user an easy way to manage assets. Another limitation of the existing solutions is the lack of diagnostic, troubleshooting and debugging tools for the system during field use; the current approach is to connect the sensor to a terminal using UART to extract the debug log file which can only be done by returning the sensor to the vendor for such analysis, which is expensive.

Battery powered IoT devices, though recent, have been growing because it is a more cost effective solution compared to wiring up all the sensors. Wireless systems based on 802.11 (also known as WiFi) are ubiquitous and routinely used to connect to the internet. US patent application U.S. Ser. No. 13/867,775 describes an IoT device with WiFi capability. The advantage of such IoT devices is that WiFi wireless networks compared to other wireless technologies is the widespread WiFi infrastructure in place, the much better security, and availability of low cost receivers in any electronic store. However, WiFi sensors have not been common because of the high power requirements of a WiFi wireless transceiver. A battery powered WiFi transceiver will last less than 8 hours of continuous operations using a Lithium AA battery. Recent innovations have produced low power WiFi modules that are now being used to create IoT sensors for a myriad of applications from environmental monitoring, to monitoring of freezers and refrigerators in hospitals or food storage applications, to energy monitoring.

An advantage of WiFi based IoT devices is an established WiFi network in most businesses and many homes. Though the data from the IoT device goes into a smartphone or tablet the display on the IoT device is limited. Additionally, the WiFi network in the enterprise settings have a very high level of encryption and security. Typically, IoT devices do not have the resources in terms of memory or processing power to meet the security requirement. In addition, as the number of IoT devices in a network increase there are no cost effective tool to monitor the IoT devices remotely and continuously. There is a need of a system that is easy to setup and does not require modifying the existing network and increases awareness of activities in the network and to detect anomalous activities.

As evidenced by the effort of previous workers, there is a need for a wireless monitoring solution that is scalable, affordable, monitors remotely, continuously the product temperature inside storage equipment while also monitoring the storage equipment performance. The system should include a way to monitor the IoT device itself in the same monitoring solution. By way of example, the invention has been applied to Storage equipment but it would be recognized that the invention has a much broader range of applicability such as warehouses and environmentally controlled units.

### BRIEF SUMMARY OF THE INVENTION

The summary is provided to describe in a simplified form the concepts of the current invention. It is not intended to identify key features of the claimed subject matter or to describe each disclosed embodiment or every implementation of the claimed subject matter, and is not intended to be used as an aid in determining the scope of the claimed subject matter.

An embodiment of the present invention provides a method and system for monitoring of storage equipment and the product inside using low power WiFi based IoT device that uses bluetooth on smart phones or tablets for configuration of the WiFi settings, to troubleshoot during and after installation, to debug and perform diagnostics; automatically detecting the type of sensor; transmitting the sensor measurement directly to the internet cloud through a WiFi network with enterprise class WiFi security. The system can be configured in such a way that the sensors can last for extended period of time using standard batteries, such as alkaline or lithium or rechargeable, available to customers. The low cost, ease of setup and other advantages and benefits of the present invention will become apparent from the detailed description of the invention.

The present invention represents a substantial advance over prior systems used for storage applications. Because the present invention uses a unique temperature probe design with multiple sensors that makes it possible to simultaneously monitor air temperature in the cold storage equipment and the temperature of the product. The air temperature is necessary to measure the storage equipment performance and the product temperature is needed to meet compliance. In another embodiment, a dual probe system to monitor cold storage equipment where one temperature sensor is immersed in glycol to mimic the temperature of the product stored in the cold storage unit and the second temperature sensor is in the handle of the probe measuring the air temperature. The probe measures both the air temperature and the product temperature at the same time.

In an embodiment, the system includes an accessory called the IoT supervisor for use in the field during and after installation of IoT devices; it is in the same WiFi network, sniffing the wireless packets to monitor the health of the IoT sensors. In another embodiment the sniffer operates in the monitor mode that allows passively sniffing packets without joining or associating with an access point, capturing the full contents of all network traffic and processing this traffic to extract the NetFlow data on the sniffing device then pushed out to the cloud. The sniffer can troubleshoot if a sensor is not seen in the cloud or when it is not behaving as per specifications.

In an embodiment, the system includes multiple pub/sub infrastructure with multiple services for sensor data collection, configuration and management. The IoT sensor connects to the different services directly through an application programming interface (API) to enable the transfer of real-time data between the sensor and the specific service running on the pub/sub engine. The services are independently deployed, scaled, and managed. The services include services for the sensor measurements, sensor commands, software updates, sensor configurations, and other remote interactions with the sensor. In another embodiment, the services includes sensor management such as sensor certification, add new sensors, replace sensors and validate sensors. Each one of the services are auto-scalable, configurable, independently maintainable, independently authenticated, and support multi-tenancy to allow many customer networks to be connected to the services, making it possible to independently deploy and scale these services.

In an embodiment, the system includes data analytics services to calculate the performance of the storage equipment using the sensor data. The data from the IoT device is maintained within a data warehouse in the cloud. This data is analyzed to create models of normal operations of the storage equipment. Deviations from the normal operations is marked as potential degradation of the equipment. The model for normal operations of the storage equipment is based on the baseline set for the specific instance of the equipment. Another embodiment combines the baseline for the specific class of storage equipment with the baseline operating conditions of the specific instance of the storage equipment. An embodiment of the model includes the variation of compressor cycle over time. An embodiment of the method includes inferring the compressor cycle via the temperature readings of the IoT sensor within the storage equipment. An embodiment of the model is updated over time to create new baseline conditions after maintenance or other interventions of the storage equipment. An embodiment of the model includes machine learning models that are learned from the data of the specific storage equipment and or the class of the storage equipment. An embodiment of the system includes building and maintaining of the storage equipment performance model within the cloud storage or database accessible via a service interface.

In an embodiment, a method for maintenance in the field while the sensor is still operating wherein the sniffer can be remotely configured to get all communication that takes place between the IoT sensor and the wireless network and streamed to the IoT cloud for further analysis. In addition, the IoT sensor can be configured for debug mode when a complete live log file can be seen on a smartphone or tablet via bluetooth; the log file can then be uploaded directly to the IoT cloud for analysis.

In an embodiment, the system includes tracking the IoT sensor from its manufacturing to certification to installation to field use to end-of-life; traceability is valued in heavily regulated application, and oftentimes this information is either in printed forms or separate databases that have nothing to do with monitoring. With the advent of smartphones and tablets it has become easier to provide all kinds of information to the end user. In addition, APIs for digital assistants that are becoming available. Amazon's Alexa and Google's digital home are recent examples. Integrating such assistants to the IoT cloud is a unique way to provide push notifications to the end user as well as provide the end user the means to interact with the IoT cloud for searches and data analytics.

### BRIEF DESCRIPTION OF THE DRAWINGS

It is noted that the appended drawings illustrate only exemplary embodiments of the invention and are, therefore, not to be considered limiting of its scope, for the invention may admit to other equally effective embodiments. For the present invention to be clearly understood and readily practised, the present invention will be described in conjunction with the following figures, wherein:

FIG. 1 is a diagram illustrating the hardware of the sensor;

FIG. 2 is a diagram illustrating the probe design with dual temperature probe inside a glycol bottle for equipment performance monitoring

FIG. 3 is a diagram illustrating the hardware of the IoT supervisor;

FIG. 4 is a typical diagram of IoT platforms now provided by Google or Amazon or Microsoft or others;

FIG. 5 is a diagram of the data flow in the proposed IoT cloud system;

FIG. 6 is a diagram of the data flow from the IoT supervisor;

FIG. 7 is a diagram of user interaction with the IoT cloud.

### DETAILED DESCRIPTION OF THE INVENTION

While the present invention will be described more fully it is to be understood at the outset of the description which follows that persons of skill in the appropriate arts may modify the invention herein described while still achieving the favorable results of this invention. Accordingly, the description which follows is to be understood as being a broad, teaching disclosure directed to persons of skill in the appropriate arts, and not as limiting upon the present invention.

First briefly in overview, the present invention according to one or more embodiments is a unique device, called Sentinel Next, with sensors, WiFi and bluetooth communication system, software programs, and related business methods for sensor monitoring using low power WiFi based wireless devices that work with the IoT cloud and smart phones and tablets. The system is for commercial use therefore it has to be stable and have long life. In addition, it has the advantage of using existing WiFi infrastructure where available as well as the internet cloud for remote monitoring.

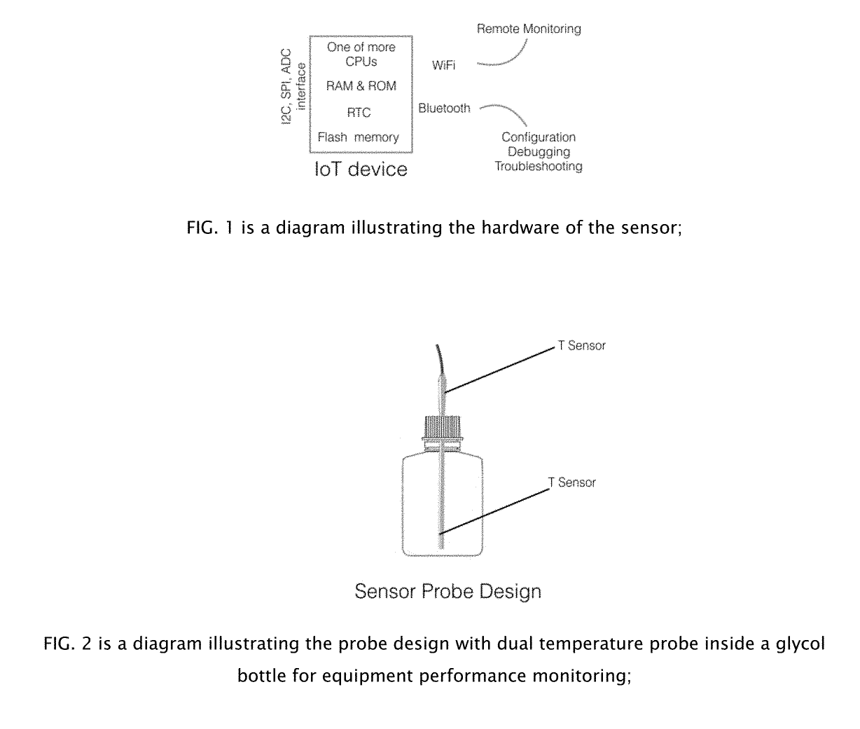

FIG. 1 illustrates the various modes of wireless communications available on the Sentinel Next as well as the various sensor interfaces that can be used to connect a myriad of sensors to the device. The dual CPU allows the sensor measurement to continue in the low power mode while the wireless portion of the device is in deep sleep thereby conserving power. The current invention uses low power WiFi for monitoring, the sensor circuitry for measuring or sensing and automatically detecting the type of sensor; and bluetooth communications for configuring the IoT sensor using smart phones or tablets, to troubleshoot during and after installation, to debug and perform diagnostics; transmitting the sensor measurement directly to the internet cloud through a WiFi network with enterprise class WiFi security. The system can be configured in such a way that the sensors can last for extended period of time using standard batteries, such as alkaline or lithium or rechargeable, available to customers. The low cost, ease of setup and other advantages and benefits of the present invention will become apparent from the detailed description of the invention.

The current invention proposes using WiFi wireless (uses one of the ISM bands between 2.4-2.4835 GHz) for communications between the IoT sensor and the IoT cloud. The wireless network can have one of the many possible securities including WEP, WPA or WPA2 enterprise or WPA2 with the EAP extension. All these security protocols were supported even though some of these security encryptions are known to be difficult to implement on embedded devices because of the limited memory and CPU.

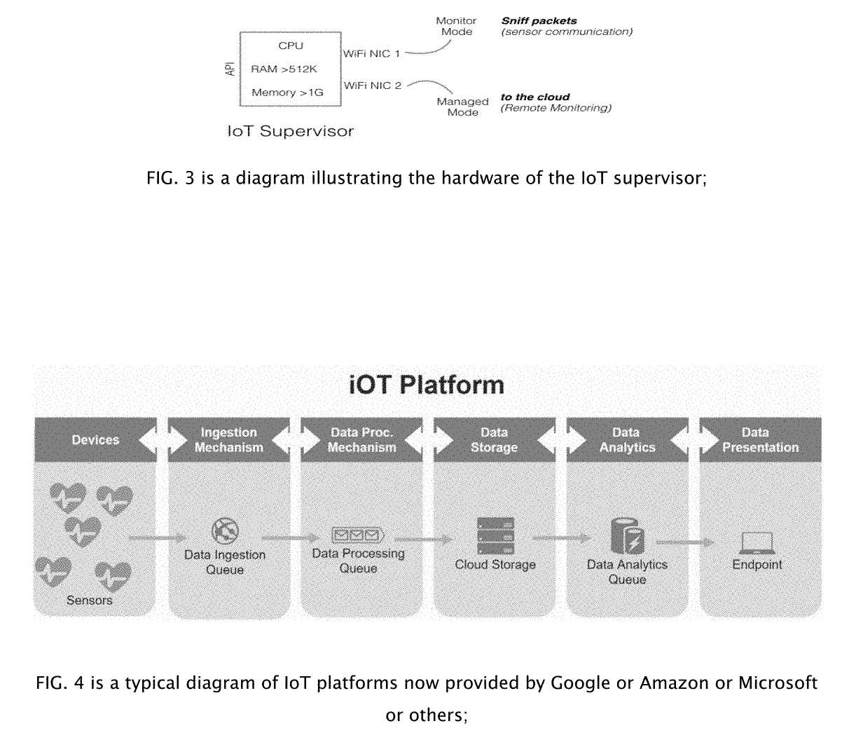

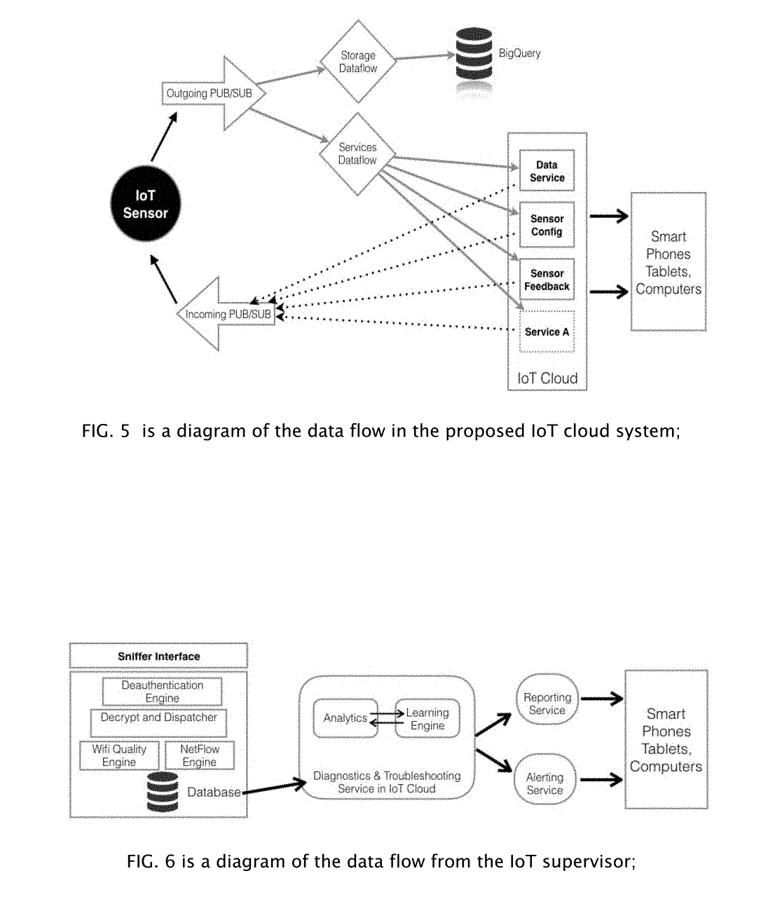

In the current invention the IoT cloud is used to make the solution scalable and eliminate the need for gateways as the cloud has almost limitless resource to ingest data from an IoT device (or sensor). FIG. 3 illustrates the various capabilities and functionalities available commercially on a typical IoT cloud. In the current invention a software architecture is designed for monitoring from one location storage units spread across multiple sites. A publish-subscribe (pub/sub) method communications is used between the IoT sensor and the cloud. FIG. 4 illustrates the dataflow and communication that includes the use of multiple pub/sub infrastructure with multiple services for sensor data collection, configuration and management.

FIG. 4 further illustrates that the IoT sensor connects to the different services directly through an application programming interface (API) to enable the transfer of real-time data between the sensor and the specific service running on the pub/sub engine; the IoT sensor is an IP device in the network that communicates with the IoT cloud using http or https type communication commonly used for browsing thereby bypassing all problems associated with port blocking. The services running on the IoT cloud are independently deployed, scaled, and managed. The services include services for sensor measurements, sensor commands, software updates, sensor configurations, and other remote interactions with the sensor. Further, the services include sensor management such as sensor certification, add new sensors, replace sensors and validate sensors. Each one of the services are auto-scalable, configurable, independently maintainable, independently authenticated, and support multi-tenancy to allow many customer networks to be connected to the services, making it possible to independently deploy and scale these services.

The IoT cloud also includes a service to trace the IoT sensor history from creation (manufacturing) of the sensor to validating and installing in the field, to managing sensor certifications to meet various compliance requirements. Such traceability of sensor is critical for large scale deployments of thousands of sensors.

The present invention is ideally suited to monitor the product inside the temperature controlled unit as well as the temperature controlled equipment. It represents a substantial advance over prior systems used for storage applications. Because the present invention uses a unique temperature probe design with multiple sensors that makes it possible to simultaneously monitor air temperature inside the cold storage equipment and the temperature of the product. The air temperature cycles with the functioning of the temperature controlled storage unit that correlates to the storage equipment performance; while the product temperature is necessary to prevent product loss and meet compliance requirements depending on the type of product. For example, the product temperature for vaccines are different than for tissue in cold storage.

In another embodiment, the dual temperature probe system wirelessly transmits the sensor data to an IoT cloud with a service type of architecture that processes the sensor data for multiple purposes including providing operational information for compliance as well as to prevent product loss; in addition, strategic information in terms of how resources are utilized, learning of best practices between sites and in selection of make and model of storage equipment for replacement and growth needs, is possible with this new simple probe design that measure the product temperature using a buffering medium such as glycol.

Existing solutions have limitations for large deployment of sensors in terms of how to manage these sensors during and post installations. In an embodiment of this invention is the monitoring of the health of the IoT sensor including tools for troubleshooting and diagnostics. The invention proposes a method and system, called the IoT supervisor, to monitor and manage the sensors remotely include sniffers, the IoT cloud and apps; using of the bluetooth mode for local troubleshooting and debugging. FIG. 6 illustrates the design of a sniffer, a key component of the IoT supervisor, includes two WiFi chips or NICs (network interface cards) with a microcomputer which is a low cost embedded device that runs a linux or windows or similar operating system. The sniffer disclosed herein, one of the WiFi NICs is used in the monitor mode that allows passively sniffing packets without joining the wireless network. The other WiFi NIC joins the network in the managed mode by authenticating using the SSID and password. It then passes the SSID and password to local processor enabling decryption of the packets sniffed by the WiFi NIC in the monitor mode. The sniffer then processes the packets in to NetFlow data and other network activity data that is then stored onboard until it pushes the data onto the appropriate service on the IoT cloud through an API.

The other key component of the IoT supervisor is in the IoT cloud that includes the micro-service, analytics and deep learning. The analytics looks for known anomalies in communication pattern between the sensor and the cloud and flags them through the alerting engine. However, the network in which the sensors operate in, is complex therefore difficult to know if there is a problem therefore the deep learning engine in the IoT cloud provides guidance regarding sensor health.

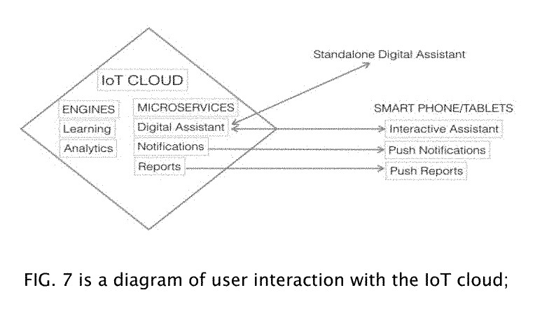

FIG. 7 illustrates the IoT cloud communication to apps on smartphones or tablets or directly to digital assistants. The end users in a commercial organization, that deploy these IoT sensors get different types of information. The digital assistant is interactive therefore the user can ask questions and the assistant will respond using the various microservices available to it. The operations group is typically interested in the proper storage of the product (being stored) to prevent product loss and meet the compliance requirements; alerting engine in the IoT cloud sends alerts when the product conditions breach the thresholds or if the sensor health such as low battery condition requires attention. In addition, the IoT cloud keeps track and send alerts for annual certifications and validation for the IoT sensor. The maintenance group is interested in the proper working of the storage equipment and the analytics engine in the IoT cloud can provide the information on the condition of the storage equipment. The analytical engine can also provide the performance information for equipment selection to the purchasing group. The purchasing group's interest is picking the right equipment and leverage the budget. Groups that are involved in creating efficiencies across organizations would be interested in the analytics and deep learning aspect of the solution.

What is claimed is:

1. A method for monitoring of storage systems using low power WiFi based wireless sensor device that will work with smart phones and tablets, the method comprising:
battery powered WiFi wireless sensor device for detection or sensing;
the smart phone or tablet for provisioning using bluetooth;
a wireless network to transmit the sensor messages or data for processing in an IoT cloud;
extracting the information from the IoT cloud to a smartphone or tablet or digital assistant; and
activating sensors to make measurements periodically or continuously;

2. The method of claim 1 wherein the wireless sensor is battery powered, has onboard memory to save sensor data and an onboard connector that includes I2C, SPI, and analog to digital interfaces to connect to sensor probes that can connect to these interfaces with auto-detection of the type of sensor probe by the wireless sensor device.

3. The method of claim 1 wherein the wireless sensor detects or senses temperature, relative humidity, carbon dioxide, differential pressure, water, dry contact and 4-20 mA signal.

4. The method of claim 1 wherein the sensor data measured by the WiFi wireless sensor device is transmitted using 802.11 with security via a WiFi access point to the IoT cloud onto the smartphone or tablet.

5. The method of claim 1 wherein the wireless sensor firmware is updated over the air with no user intervention, through an IoT cloud.

6. The method of claim 1 wherein the IoT cloud sends and receives messages from the sensor through a publish-subscribe API using a collection of microservices.

7. The method of claim 1 wherein the IoT cloud uses the data store API and machine learning API to extract information.

8. The method of claim 1 wherein the IoT cloud has complete traceability information of the wireless sensor from manufacturing to certification to installation to field use to end-of-life.

9. The method of claim 1 wherein a smartphone or tablet receive actionable alerts and reports about the health of the storage system.

10. The method of claim 1 wherein a digital assistant interacts with the end user and provides the requested information.

11. A system for monitoring the air temperature and the stored product temperature inside a temperature controlled unit, the system comprising:
a WiFi wireless sensor device for measuring air temperature and stored product temperature at the same time;
a wireless network to transmit the temperature data and statistics for processing in an IoT cloud;
extracting the health information of the temperature controlled unit from the IoT cloud; and
communicating the alerting and health information to a smartphone or a tablet or a digital assistant;

12. The method of claim 11 wherein the wireless sensor measures temperature in the range of −200 C to +100 C.

13. The method of claim 11 wherein the wireless sensor measures the stored product temperature using a buffering medium.

14. The method of claim 11 wherein the wireless network has WPA or WPA2 Enterprise security.

15. The method of claim 11 wherein the IoT cloud sends and receives messages from the sensor through a publish-subscribe API and uses the data store API and machine learning API to extract information.

16. The method of claim 11 wherein the IoT cloud generates an aggregated report on the performance of all temperature controlled units in the wireless network.

17. A method for troubleshooting and monitoring the health of the IoT device in a wireless network using an IoT supervisor, the method comprising:
one or more IoT supervisors are sniffers, each with one or more wireless network interface card;
a processor on the sniffer using a software to extract and process the IoT device communications;
transmitting all the IoT device packet communication for further processing in an IoT cloud;
extracting the health information of the IoT device from the IoT cloud;
communicating alerting and health information to a smartphone or a tablet or a digital assistant; and
a smartphone app for troubleshooting and debugging the IoT device.

18. The method of claim 17 wherein the sniffer is an embedded device that runs windows or linux or similar OS.

19. The method of claim 17 wherein one wireless network interface card communicates via WiFi and runs in the managed mode, connecting to the wireless network being monitored.

20. The method of claim 17 wherein the processor on the sniffer decrypts the packets and extracts the netflow, wireless communication patterns, wireless quality, and network resource utilization data.

21. The method of claim 17 wherein the sniffer stores the processed packet information.

22. The method of claim 17 wherein the IoT cloud sends and receives messages from the sniffer through a publish-subscribe API and uses the data store API and machine learning API to extract information.

23. The method of claim 17 wherein the IoT cloud generates an aggregated report on the performance of all the IoT devices in the wireless network.

24. The method of claim 17 wherein the troubleshooting and debugging of IoT device is performed locally by directly connecting it to a smartphone via bluetooth.

25. The method of claim 17 wherein the troubleshooting of IoT device is performed remotely by streaming all wireless packet information from IoT supervisor to the IoT cloud.
